(19) United States
(12) Patent Application Publication
(10) Pub. No.: US 2006/0252326 A1
(43) Pub. Date: Nov. 9, 2006

(54) Antimicrobial cubicle curtain and methods of making the same

(76) Inventor: Amy M. Mishler, Hainesville, IL (US)

Correspondence Address: Janet M. Garetto;JENKENS & GILCHRIST, A PROFESSIONAL CORPORATION, Ste. 2600, 225 W. Washington, Chicago, IL, 60606-3418, US

(21) Appl. No.: 11/416,979

(22) Filed: May 3, 2006

Related U.S. Application Data
(60) Provisional application No. 60/677,242, filed on May 3, 2005.

(51) Int. Cl. B32B 27/04

(52) U.S. Cl. 442/123

(57) ABSTRACT

An cubicle curtain is disclosed. The cubicle curtain comprises a main portion adapted to attach to a curtain track and at least one fabric band coupled with at least a portion of a corresponding at least one vertical end of the main portion. The at least a portion of the at least one fabric band has antimicrobial properties.

### CROSS-REFERENCE TO RELATED APPLICATION

This application claims the benefit of U.S. Provisional Application No. 60/677,242, filed May 3, 2005, which is hereby incorporated by reference in its entirety.

### FIELD OF THE INVENTION

The present invention relates generally to an antimicrobial cubicle curtain that significantly reduces the level of microbes present in the cubicle curtain fabric. More particularly, the present invention relates to a cubicle curtain having an antimicrobial fabric attached to a vertical edge or vertical edges of the cubicle curtain and adapted to be used in a hospital setting or other healthcare facility to prevent or inhibit microbial growth and transfer of infections.

### BACKGROUND OF THE INVENTION

Hanging curtains are often used to divide larger hospital rooms into individual patient areas or cubicles. They are useful in providing a patient with his or her own private cubicle when other patients are in the room or in higher traffic settings in a hospital or other healthcare facility such as an emergency room or post-operative recovery room. Often, the cubicle curtains are attached by hooks or other means that are slidably mounted to curtain tracks attached to the ceiling of the hospital room or other healthcare facility. The slidable mounting makes it convenient for the curtains to be moved back and forth between an open and closed position so that a health care professional, visitor, or the patient himself or herself may enter and exit the cubicle with ease.

Typically, hospital cubicle curtains are made from cloth or a cloth-like material. Due to the fibrous nature of this type of material, the cubicle curtains often become a haven for bacteria and microbial growth. Bacteria and germs are transmitted to and from the cubicle curtains through the air or by physical contact, often by the hands of a health care provider who did not have an opportunity to wash his or her hands after examining the patient and before exiting the cubicle. Because of this, bacteria and microbes often become nestled in the cubicle curtain, particularly in the vertical edges. The vertical edges are the parts of the cubicle curtain handled most frequently as patients, healthcare providers, visitors, and the like open and/or close the cubicle curtain. Thus, the vertical edges of the cubicle curtain are often the most contaminated parts of the cubicle curtain. The constant contact of the cubicle curtain by many different individuals creates significant hygiene issues that may lead to serious illness and/or disease. In addition, due to time and cost constraints, hospitals and other healthcare facilities do not launder the cubicle curtains as often as is needed to maintain an environment having a low level of bacteria and microbes.

Therefore, there exists a need to create an affordable cubicle curtain that significantly reduces the growth and spread of bacteria and microbes.

### SUMMARY OF THE INVENTION

According to one embodiment of the present invention, a cubicle curtain comprises a main portion adapted to attach to a curtain track and at least one fabric band coupled with at least a portion of a corresponding at least one vertical end of the main portion. The at least a portion of the at least one fabric band has antimicrobial properties.

According to another embodiment of the present invention, a cubicle curtain comprises an upper portion adapted to attach to a curtain track, a main portion attached to a bottom part of the upper portion, and at least one fabric band coupled with at least a portion of a corresponding at least one vertical end of the main portion. The at least a portion of the at least one fabric band has antimicrobial properties.

According to another embodiment of the present invention, a method of making a cubicle curtain is disclosed. The method comprises the acts of providing a first portion adapted to attach to a curtain track. The method further comprises coupling at least a portion of at least one fabric band with at least a portion of a corresponding at least one vertical edge of the first portion. The at least a portion of the at least one fabric band has antimicrobial properties.

According to another embodiment of the present invention, a method of fitting an antimicrobial band to a cubicle curtain is disclosed. The method comprises the act of providing a cubicle curtain. The method further comprises coupling at least a portion of at least one fabric band to at least a portion of at least one vertical edge of the cubicle curtain. The at least one fabric band has antimicrobial properties.

According to another embodiment of the present invention, a fabric band comprises at least one fabric having antimicrobial properties. The fabric band further comprises at least one attachment means positioned on the fabric band. The fabric band is adapted to be coupled to at least a portion of a vertical end of a cubicle curtain to inhibit microbial growth.

The above summary of the present invention is not intended to represent each embodiment or every aspect of the present invention. The detailed description and Figures will describe many of the embodiments and aspects of the present invention.

### BRIEF DESCRIPTION OF THE DRAWINGS

The foregoing and other advantages of the invention will become apparent upon reading the following detailed description and upon reference to the drawings.

FIG. 1 is a front elevational view of a cubicle curtain according to one embodiment of the present invention.

FIG. 2 is a perspective view of a hospital room setting utilizing the cubicle curtain of FIG. 1.

FIG. 3a is a front elevational view of a cubicle curtain according to another embodiment of the present invention.

FIG. 3b is a front elevational view of a cubicle curtain according to yet another embodiment of the present invention.

FIG. 4 is a perspective view of a hospital room utilizing a cubicle curtain according to another embodiment of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention.

### DESCRIPTION OF ILLUSTRATIVE EMBODIMENTS

The present invention is directed to an antimicrobial cubicle curtain providing a significant reduction in the level of microbes and bacteria typically present in a cubicle curtain in a hospital setting or other healthcare facility.

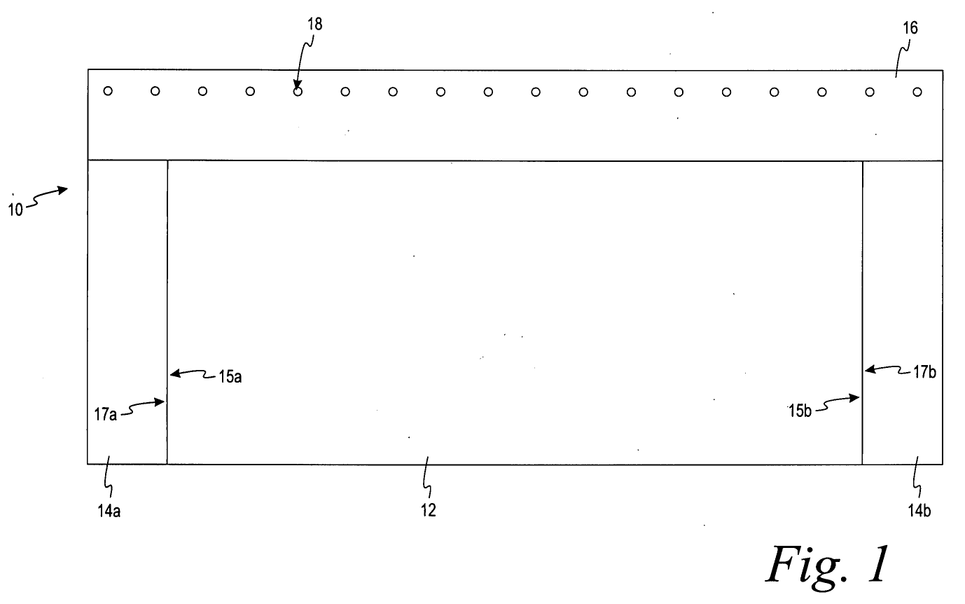

FIG. 1 shows a front elevational view of a cubicle curtain 10 of one embodiment of the present invention. The cubicle curtain 10 may be comprised of several different fabrics or materials. In the embodiment of FIG. 1, three different types of fabric are used in three different areas: a main portion 12, at least one antimicrobial fabric band 14a, 14b, and an upper portion 16.

The fabric used in the main portion 12 of the cubicle curtain 10 is generally selected based on decorative and cost considerations. The main portion 12 may be comprised of fabric including, but not limited to, polypropylene, polyethylene, polyurethane, polyester, cellulose, nylon, combinations thereof, or the like. One non-limiting example of a fabric that may be used includes a dobbie having a construction of about 113 ends per inch (EPI), about 55 picks per inch (PPI), a weight of about 10.75 oz./linear yard, and a width ranging from about 71 inches to about 72 inches. It is contemplated that other types, densities, weights, and widths of fabric may also be used. The main portion 12 may include one long piece of fabric or one or more pieces of fabric joined together to achieve a desired length and width.

According to the embodiment of FIG. 1, an antimicrobial fabric band(s) 14a, 14b is attached to at least one vertical edge of the main portion 12. The antimicrobial fabric band(s) 14a, 14b may include one piece of antimicrobial fabric or one or more pieces of antimicrobial fabric or fabrics joined together to achieve a desired length and width. It is contemplated that the antimicrobial fabric band(s) 14a, 14b may be attached to both vertical edges of the main portion 12 to minimize the growth and spread of bacteria and microbes. However, it is contemplated that if one end of the cubicle curtain 10 is intended to be stationary, and thus, not subject to constant contact, it may be unnecessary to attach an antimicrobial fabric band to that end. The one or more antimicrobial fabric band(s) 14a, 14b should be wide enough to extend across the parts of the cubicle curtain 10 most often pushed or pulled by persons opening and/or closing the cubicle curtain 10. For example, although other widths are contemplated, the width of the antimicrobial fabric band(s) 14a, 14b may generally range from about 6 inches to about 18 inches from the vertical edge of the cubicle curtain 10.

The one or more antimicrobial fabric band(s) 14a, 14b may be attached to vertical edges 15a, 15b of the main portion 12 using any means suitable for attaching the one or more antimicrobial fabric band(s) 14a, 14b to the main portion 12. For example, the antimicrobial fabric band(s) 14a, 14b may be attached to the main portion 12 using sewing, stitching, adhesive, hook-and-loop type fasteners such as Velcro®, snaps, magnets, combinations thereof, or the like.

Alternatively or additionally, the antimicrobial fabric band(s) 14a, 14b may be coupled to the main portion 12 using banding. The banding process includes folding the antimicrobial fabric band(s) 14a, 14b in half length-wise such that the fabric or material forming the antimicrobial fabric band(s) 14a, 14b is doubled. The open ends of the antimicrobial fabric band(s) 14a, 14b are then attached to the main portion 12 of the cubicle curtain 10 such that the respective vertical edge(s) 15a, 15b of the main portion 12 are adjacent to a fold generally located at or near the center of the antimicrobial fabric band(s) 14a, 14b. Thus, a vertical end(s) of the main portion 12 is sandwiched between the double layers of the antimicrobial band(s) 14a, 14b. Vertical edges 17a, 17b of the antimicrobial band(s) 14a, 14b may be attached to the vertical end(s) of the main portion 12 by sewing, stitching, adhesive, hook-and-loop type fasteners such as Velcro®, snaps, magnets, combinations thereof, or the like. The total width of the cubicle curtain 10 after banding the antimicrobial fabric band(s) 14a, 14b may remain substantially the same as the width of the cubicle curtain 10 prior to banding, or banding can increase the total width of the cubical curtain 10. The width of the antimicrobial band(s) 14a, 14b prior to being folded may range from about 12 inches to about 36 inches. It is contemplated that the length of the antimicrobial band(s) 14a, 14b may be similar to the length of the cubicle curtain 10.

The antimicrobial fabric band(s) 14a, 14b may include one long piece of fabric or one or more pieces of fabric joined together to achieve a desired length and width of the antimicrobial fabric band(s) and/or the cubicle curtain 10. In embodiments where the antimicrobial fabric band(s) 14a, 14b includes more than one piece of fabric, less than all of the pieces of fabric may have antimicrobial properties. For example, it may be desirable for a portion of fabric positioned in an area most likely to be contacted by a patient, healthcare provider, visitor, or the like to have antimicrobial properties. The remaining piece(s) of fabric need not have antimicrobial properties.

In another embodiment, the main portion 12 may include one piece of antimicrobial fabric or more than one piece of antimicrobial fabric joined together to achieve a desired length and width. Thus, one or both of the antimicrobial fabric band(s) 14a, 14b may be eliminated.

Although the bacteria and/or microbes will still come into contact with the cubicle curtain 10, they will do so most frequently on the antimicrobial fabric band(s) 14a, 14b, which will kill the bacteria and/or microbes or inhibit the growth and/or spread of the bacteria and/or microbes. The types of bacteria and/or microbes killed and/or inhibited include, but are not limited to, Methicillin-Resistant Staphylococcus Aureus (MRSA), Vancomycin-Resistant Enterococci (VRE), Klebsiella pneumoniae, E-coli, and other species of bacteria commonly found in hospitals or other healthcare facilities.

The antimicrobial effect may, for example, be achieved by incorporating silver or compounds including silver within the threads of the fabric used in the antimicrobial fabric band(s) 14a, 14b or the fabric used in forming other portions of the cubicle curtain 10. One company employing such methods is Maharam (Hauppage, N.Y.). Examples of suitable fabric patterns available from Maharam include, but are not limited to, Tickle 511320, Segue 511310, Square Line 511340, and Wander 51130.

In an alternative embodiment, an antimicrobial coating may be applied to various locations and/or portions of the cubicle curtain 10. The antimicrobial coating generally includes chlorine or chlorine stabilizing compounds that provide antimicrobial properties to the fabric used in forming the cubicle curtain 10. It is contemplated that any antimicrobial coating suitable for achieving the desired antimicrobial effect may be used. Although not intended to be bound to any particular theory of operation, the antimicrobial coating may also act to bind and stabilize chlorine to the treated surface of the fabric. This bound chlorine may then be used to kill the bacteria and/or microbes or reduce the growth and/or spread of the bacteria and/or microbes that come into contact with the fabric. The antimicrobial coating may be applied to the fabric used in forming the cubicle curtain 10 during the process of manufacturing the fabric. The fabric covered with the antimicrobial coating may be used only on the vertical edges of the cubicle curtain 10, thereby substituting for the one or more antimicrobial fabric band(s) 14a, 14b, as in FIG. 1. Alternatively, the antimicrobial coating may be applied to the entire cubicle curtain 10 such that a main portion 12 covered with the antimicrobial coating would extend over the entire width of the cubicle curtain 10 and one, two, or no antimicrobial fabric band(s) would be necessary.

One non-limiting example of an antimicrobial coating that may be used to treat the fabric of the cubicle curtain 10 is HaloShield® coating, manufactured by Vanson HaloSource, Inc. (Redmond, Wash.), which may be used to bind chlorine molecules to the fabric used in forming the cubicle curtain 10. Laundering the cubicle curtain 10 that is covered in whole or in part with the antimicrobial coating in a chlorine sanitizer or disinfectant would renew the antimicrobial effect of the coated cubicle curtain 10.

Another non-limiting example of an antimicrobial coating that may be used to treat the fabric of the cubicle curtain 10 is a chemical treatment manufactured by Aegis Environments (Midland, Mich.). The chemical treatment generally remains active on the cubicle curtain for a predetermined period of time without requiring laundering to renew the antimicrobial effect.

The upper portion 16 of the cubicle curtain 10 is attached to the top of the main portion 12 and the top of the one or more antimicrobial fabric band(s) 14a, 14b, as shown in FIG. 1. The upper portion 16 may be attached to the main portion 12 and the one or more antimicrobial fabric band(s) 14a, 14b by any suitable means, including sewing, stitching, hook-and-loop type fasteners such as Velcro®, snaps, magnets, combinations thereof, or the like. The top part of the upper portion 16 may include holes 18 located in a spaced arrangement so that curtain hooks or other suitable attachment devices may be placed through the holes 18 in order to hang the cubicle curtain 10. It is contemplated that the upper portion 16 may include other suitable attachment means adapted to be used with other attachment devices. The upper portion 16 may be made of any suitable material including, but not limited to, nylon, polypropylene, polyethylene, polyurethane, polyester, cellulose, combinations thereof, or the like. The upper portion 10 is typically made of a mesh or mesh-like material, thereby providing an opening to allow for air and water to enter into the cubicle, which may be required to meet certain fire regulations.

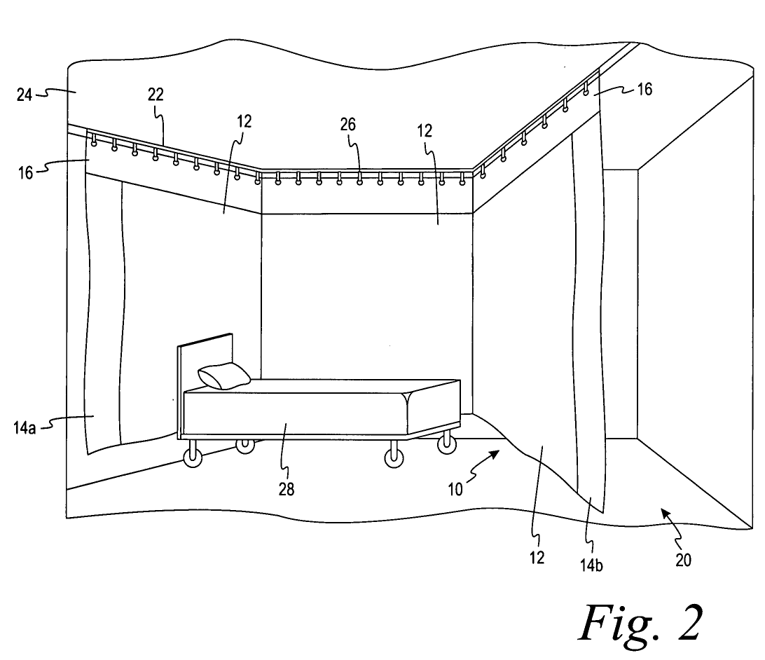

Referring now to FIG. 2, a perspective view of one embodiment of a cubicle curtain 10 of the present invention hung in a hospital room 20 is shown. The hospital room 20 includes curtain tracks 22 fixed on the ceiling 24. The curtain tracks 22 include hooks 26 that are slidably mounted on the curtain tracks 22. The upper portion 16 of the cubicle curtain 10 is hung by inserting the hooks 26 through the corresponding holes in the upper portion 16. The hooks 26 and the upper portion 16 move along the curtain tracks 22 such that the cubicle curtain 10 can be used to divide a hospital room 20 and surround a patient's bed 28 to provide privacy to the patient. It is also contemplated that the cubicle curtain 10 may be attached to the curtain tracks 22 by other suitable attachment means. The curtain track 22 may be suspended so that a space is created between the ceiling 24 and the cubicle curtain 10, in which case the upper portion 16 of the cubicle curtain 10 may be eliminated. The cubicle curtain 10 may also be moved along the curtain tracks 22 so that the cubicle curtain 10 is opened up to the hospital room 20. Generally, the vertical edge of the cubicle curtain 10 is touched when opening or closing the cubicle curtain 10. As the vertical edge is composed of an antimicrobial fabric band(s) 14a, 14b according to one embodiment of the present invention, a significant amount of the bacteria and/or microbes in the air that make contact with the vertical edge or bacteria and/or microbes on a user's hand transferred to the cubicle curtain 10 will be killed, thus substantially inhibiting the growth and/or spread of the bacteria or microbes.

The dimensions of the main portion 12 and upper portion 16 and the length of the antimicrobial fabric band(s) 14a, 14b of the cubicle curtain 10 will vary based on the architectural design of the hospital room 20, cost considerations, design considerations, safety regulations, and the like. These dimensions should be sufficient to enclose the patient's bed 28 and private area. The thickness of the main portion 12, the upper portion 16, and the one or more antimicrobial fabric band(s) 14a, 14b generally range from about 0.5 mm to about 10 mm. It is contemplated that other thicknesses may be used in the embodiments of the present invention. The fabrics used in the main portion 12, the one or more antimicrobial fabric band(s) 14a, 14b, and the upper portion 16 may be available in various colors.

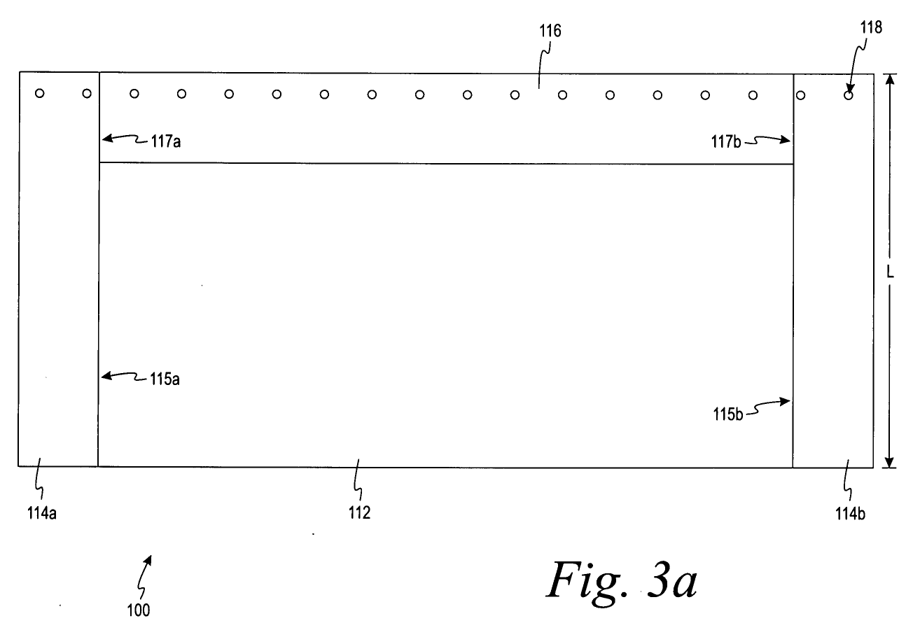

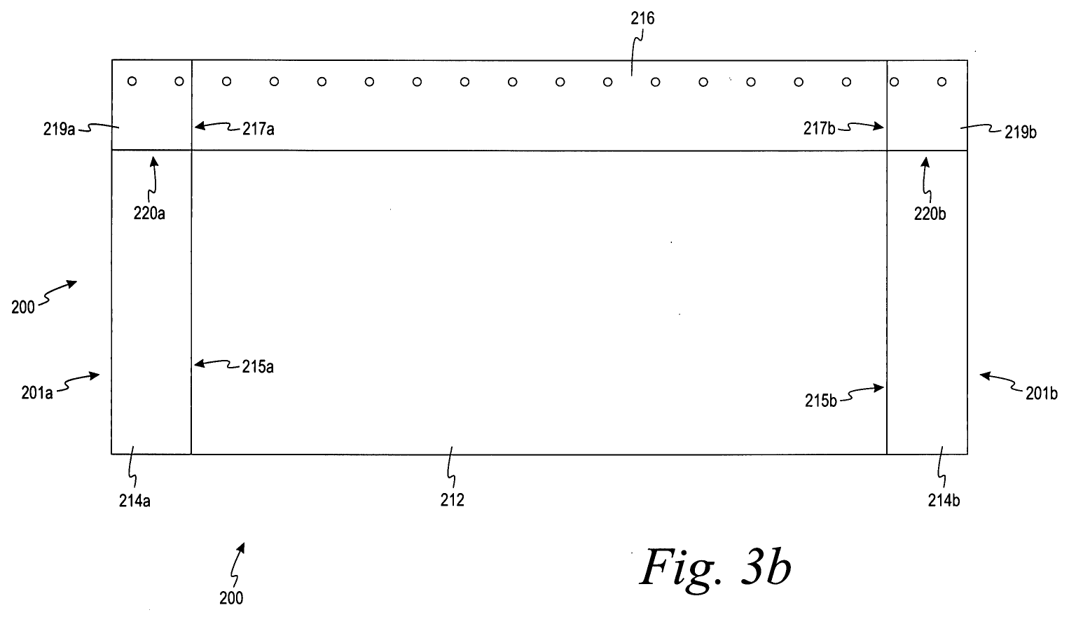

According to another embodiment illustrated in FIG. 3a, a cubicle curtain 100 includes a main portion 112, one or more antimicrobial fabric band(s) 114a, 114b, and an upper portion 116. The cubicle curtain 100 is generally similar to the cubicle curtain 10 shown in FIGS. 1 and 2 and described above. However, in the embodiment of FIG. 3a, the antimicrobial fabric band(s) 114a, 114b are coupled to vertical edges 115a, 115b of the main portion 112 and vertical edges 117a, 117b of the upper portion 116. The antimicrobial fabric band(s) 114a, 114b have a length L similar to the combined length of the upper portion 116 and the main portion 112. Additionally, the antimicrobial fabric band(s) 14a, 14b may include holes 118 in a spaced arrangement positioned near the top of the antimicrobial fabric band(s) 114a, 114b. The holes 118 are positioned such that curtain hooks or other suitable attachment devices may be placed through the holes 118 in order to hang the antimicrobial fabric band(s) 114a, 114b portion of the cubicle curtain 100. The antimicrobial fabric band(s) 114a, 114b may be coupled to the vertical edges 115a, 115b of the main portion 112 and vertical edges. 117a, 117b of the upper portion 116 by any suitable means including, but not limited to, sewing, stitching, adhesive, hook-and-loop type fasteners such as Velcro®, snaps, magnets, combinations thereof, or the like. The types of fabric(s) used to make the main portion 112, the antimicrobial fabric band(s) 114a, 114b, and/or the upper portion 116 may include any suitable fabric(s) including, but not limited to, those described above with respect to the cubicle curtain 10 (FIGS. 1 and 2). It is also contemplated that the dimensions of the various portions of the cubicle curtain 100, the ways of attaching the various portions of the cubicle curtain 100, the antimicrobial characteristics, and the like may be similar to that described above with respect to the cubicle curtain 10 (FIGS. 1 and 2). Furthermore, it is contemplated that the cubicle curtain 100 may be used in manners similar to those described above with respect to the cubicle curtain 10 (FIGS. 1 and 2).

As shown in the embodiment of FIG. 3b, a cubicle curtain 200 includes one or more fabric band(s) 201a, 201b comprising a corresponding one or more antimicrobial fabric portion(s) 214a, 214b and a corresponding one or more top portion(s) 219a, 219b. The antimicrobial fabric portion(s) 214a, 214b is similar to the antimicrobial fabric band(s) 14a, 14b described above with respect to FIGS. 1 and 2 and the antimicrobial fabric bands 114a 114b described above with respect to FIG. 3a. The top portion(s) 219a, 219b may be made of any suitable material including, but not limited to, nylon, polypropylene, polyethylene, polyurethane, polyester, cellulose, combinations thereof, or the like. The top portion(s) 219a, 219b is typically made of a mesh or mesh-like material, thereby providing an opening to allow for air and water to enter into the cubicle, which may be required to meet certain fire regulations. At least a portion of the top portion(s) 219a, 219b is coupled to a vertical edge(s) 217a, 217b of an upper portion 216 of the cubical curtain 200. Additionally, a portion of the top portion(s) 219a, 219b may be coupled to a vertical edge(s) 215a, 215b of a main portion 212. The top portion(s) 219a, 219b is also generally coupled to an upper edge(s) 220a, 220b of the antimicrobial fabric portion(s) 214a, 214b. The top portion(s) 219a, 219b may be coupled to the upper portion 216, the main portion 212, and/or the antimicrobial portion(s) 214a, 214b by any suitable means including, but not limited to, sewing, stitching, adhesive, hook-and-loop type fasteners such as Velcro®, snaps, magnets, combinations thereof, or the like.

The types of fabric(s) used to make the main portion 212, the antimicrobial portion(s) 214a, 214b, and/or the upper portion 216 may include any suitable fabrics including, but not limited to, those described above with respect to the cubicle curtains 10 (FIGS. 1 and 2) and 100 (FIG. 3a). It is also contemplated that the dimensions of the various portions of the cubicle curtain 200, the ways of attaching the various portions of the cubicle curtain 200, the antimicrobial characteristics, and the like may be similar to those described above with respect to the cubicle curtains 10 (FIGS. 1 and 2) and 100 (FIG. 3a). Furthermore, it is contemplated that the cubicle curtain 200 may be used in manners similar to those described above with respect to the cubicle curtains 10 (FIGS. 1 and 2) and 100 (FIG. 3a).

It is contemplated that the antimicrobial fabric band(s) 114a, 114b and/or the fabric band(s) 214a, 214b of FIGS. 3a and 3b, respectively, may be retrofitted to existing cubicle curtains. Although the cubicle curtains 100, 200 of the embodiments of FIGS. 3a and 3b include two antimicrobial fabric bands 114a, 114b or fabric bands 214a, 214b, it is contemplated that the cubicle curtain 100, 200 may include only one antimicrobial fabric band 114a, 114b or fabric band 214a, 214b.

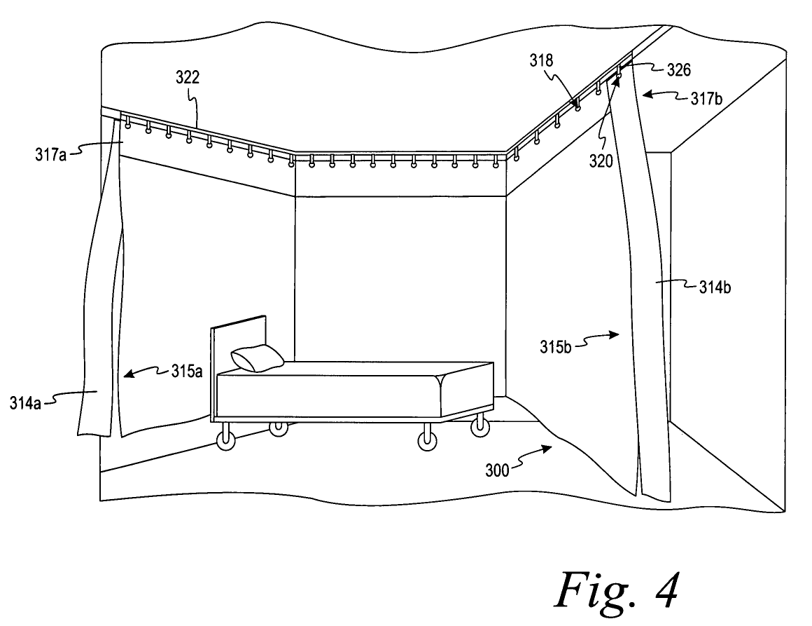

FIG. 4 shows a cubicle curtain 300 having an antimicrobial fabric band(s) 314a, 314b according to another embodiment of the present invention. According to the embodiment of FIG. 4, the antimicrobial fabric band(s) 314a, 314b is coupled to a portion of the cubicle curtain 300. For example, the antimicrobial fabric band(s) 314a, 314b may be attached to a top corner area(s) 317a, 317b or any other suitable area of the cubicle curtain 300. The antimicrobial fabric band(s) 314a, 314b need not be directly attached to the cubicle curtain 300. In embodiments where the antimicrobial fabric band(s) 314a, 314b is directly attached to the cubicle curtain 300, it is contemplated that the antimicrobial fabric band(s) 314a, 314b may be attached at any number of locations.

According to the illustrated embodiment, the antimicrobial fabric band(s) 314a, 314b includes at least one hole 320 such that at least one curtain hook 326 slidably attached to a curtain track 322 may be placed through the at least one hole 320 in order to hang the antimicrobial fabric band(s) 314a, 314b. The at least one curtain hook 320 is also placed through a cubicle curtain hole 318 positioned at the top corner area(s) 317a, 317b and closest to a vertical edge(s) 315a, 315b of the cubicle curtain 300. It is contemplated that the antimicrobial fabric band(s) 314a, 314b may include other suitable attachment means adapted to be used with attachment devices other than the curtain track 322 shown in the illustrated embodiment. In use, the visitor, patient, healthcare professional, or the like may grasp and pull the antimicrobial fabric band 314a, 314b, thereby causing the cubicle curtain 300 to open and/or close accordingly.

Alternatively or additionally, a portion of the antimicrobial fabric band(s) 314a, 314b of FIG. 4 may be attached to a portion of the cubicle curtain 300. For example, a top end of the antimicrobial fabric band(s) 314a, 314b may be attached to a portion of the cubicle curtain 300 (i.e., the top corner area(s) 317a, 317b or another suitable portion) using sewing, stitching, adhesive, hook-and-loop type fasteners such as Velcro®, snaps, magnets, combinations thereof, or the like.

The antimicrobial fabric band(s) 314a, 314b may be comprised of one or more pieces of fabric to achieve a desired width and/or length of the antimicrobial fabric band(s) 314a, 314b and/or the cubicle curtain 300. In embodiments where the antimicrobial fabric band(s) 314a, 314b includes more than one piece of fabric, less than all of the pieces of fabric may have antimicrobial properties. For example, it may be desirable for a piece(s) of fabric positioned in an area most likely to be contacted by a patient, visitor, healthcare professional, or the like to have antimicrobial properties. The remaining piece(s) of fabric need not have antimicrobial properties. The length of the antimicrobial fabric band(s) 314a, 314b may be similar to the length of the cubicle curtain 300. It is contemplated that the length of the antimicrobial fabric band(s) 314a, 314b may be shorter or longer than the length of the cubicle curtain 300.

Although the cubicle curtain 300 of FIG. 4 includes two antimicrobial fabric bands 314a, 314b, it is contemplated that the cubicle curtain 300 may include only one antimicrobial fabric band 314a, 314b. It is further contemplated that the antimicrobial band(s) 314a, 314b may include a top portion similar to the top portion 219a, 219b of FIG. 3b for allowing air and water to enter into the cubicle.

The types of fabric(s) used to make the antimicrobial fabric band(s) 314a, 314b may include any suitable fabric(s) including, but not limited to, those described above with respect to the cubicle curtains 10 (FIGS. 1 and 2), 100 (FIG. 3a), and 200 (FIG. 3b). Alternatively or additionally, the antimicrobial fabric band(s) 314a, 314b may have an antimicrobial coating such as that described above with respect to the cubicle curtains 10 (FIGS. 1 and 2), 100 (FIG. 3a), and 200 (FIG. 3b). It is also contemplated that the dimensions, characteristics, and the like of the antimicrobial fabric band(s) 314a, 314b may be similar to those described above with respect to the cubicle curtains 10 (FIGS. 1 and 2), 100 (FIG. 3a), and 200 (FIG. 3b). It is contemplated that the antimicrobial fabric band(s) 314a, 314b may include one or more weights at or near the bottom of the antimicrobial fabric band(s) 314a, 314b to inhibit or prevent the antimicrobial fabric band(s) 314a, 314b from being blown or moved.

According to alternative embodiment A, a cubicle curtain comprises a main portion adapted to attach to a curtain track and at least one fabric band attached to a corresponding at least one vertical edge of the main portion, the at least one fabric band having antimicrobial properties.

According to alternative embodiment B, the cubicle curtain of alternative embodiment A, wherein the at least one fabric band comprises a fabric having antimicrobial properties.

According to alternative embodiment C, the cubicle curtain of alternative embodiment B, wherein the fabric includes silver.

According to alternative embodiment D, the cubicle curtain of alternative embodiment A, wherein the at least one fabric band comprises a coating containing chlorine, a chlorine-stabilizing compound, or a combination thereof.

According to alternative embodiment E, the cubicle curtain of alternative embodiment A, wherein the main portion contains a plurality of holes adapted to attach to the curtain track by receiving a plurality of hooks slidably mounted to the curtain track.

According to alternative embodiment F, the cubicle curtain of alternative embodiment A, wherein the width of the at least one fabric band ranges from about 6 inches to about 18 inches.

According to alternative embodiment G, the cubicle curtain of alternative embodiment A, wherein the at least one fabric band is attached to the cubicle curtain by banding.

According to alternative embodiment H, the cubicle curtain of alternative embodiment A, wherein the at least one fabric band is two fabric bands, each of the two fabric bands being attached to a corresponding vertical edge of the main portion.

According to alternative embodiment I, a cubicle curtain comprises an upper portion adapted to attach to a curtain track, a main portion attached to a bottom part of the upper portion, and at least one fabric band attached to a corresponding at least one vertical edge of the main portion, the at least one fabric band having antimicrobial properties.

According to alternative embodiment J, the cubicle curtain of alternative embodiment I, wherein the at least one fabric band comprises a fabric having antimicrobial properties.

According to alternative embodiment K, the cubicle curtain of alternative embodiment J, wherein the fabric includes silver.

According to alternative embodiment L, the cubicle curtain of alternative embodiment I, wherein the at least one fabric band comprises a coating containing chlorine, a chlorine-stabilizing compound, or a combination thereof.

According to alternative embodiment M, the cubicle curtain of alternative embodiment I, wherein the upper portion contains a plurality of holes adapted to attach to the curtain track by receiving a plurality of hooks slidably mounted to the curtain track.

According to alternative embodiment N, the cubicle curtain of alternative embodiment I, wherein the width of the at least one fabric band ranges from about 6 inches to about 18 inches.

According to alternative embodiment O, the cubicle curtain of alternative embodiment I, wherein the at least one fabric band is attached to the cubicle curtain by banding.

According to alternative embodiment P, the cubicle curtain of alternative embodiment I, wherein the at least one fabric band is two fabric bands, each of the two fabric bands being attached to a corresponding vertical edge of the main portion.

According to alternative embodiment Q, the cubicle curtain of alternative embodiment I, wherein a top part of the at least one fabric band is attached to the bottom part of the upper portion.

According to alternative embodiment R, a cubicle curtain comprises a main portion adapted to attach to a curtain track and at least one fabric band coupled with at least a portion of a corresponding at least one vertical end of the main portion, at least a portion of the at least one fabric band having antimicrobial properties.

According to alternative embodiment S, the cubicle curtain of alternative embodiment R, wherein the at least one fabric band comprises a coating including chlorine, a chlorine-stabilizing compound, or a combination thereof.

According to alternative embodiment T, the cubicle curtain of alternative embodiment R, wherein the main portion comprises a plurality of holes adapted to attach to the curtain track by receiving a plurality of hooks slidably mounted to the curtain track.

According to alternative embodiment U, the cubicle curtain of alternative embodiment T, wherein the at least one fabric band comprises at least one hole adapted to attach to the curtain track by receiving at least one of the plurality of hooks.

According to alternative embodiment V, the cubicle curtain of alternative embodiment U, wherein one of the plurality of holes positioned at or near at least one end of the main portion receives the at least one of the plurality of hooks.

According to alternative embodiment W, the cubicle curtain of alternative embodiment R, wherein the width of the at least one fabric band ranges from about 6 inches to about 36 inches.

According to alternative embodiment X, a cubicle curtain comprises an upper portion adapted to attach to a curtain track, a main portion attached to a bottom part of the upper portion, and at least one fabric band coupled with at least a portion of a corresponding at least one vertical end of the main portion, at least a portion of the at least one fabric band having antimicrobial properties.

According to alternative embodiment Y, the cubicle curtain of alternative embodiment X, wherein the at least one fabric band comprises a coating including chlorine, a chlorine-stabilizing compound, or a combination thereof.

According to alternative embodiment Z, the cubicle curtain of alternative embodiment X, wherein the upper portion includes a plurality of holes adapted to attach to the curtain track by receiving a plurality of hooks slidably mounted to the curtain track.

According to alternative embodiment AA, the cubicle curtain of alternative embodiment X, wherein the width of the at least one fabric band ranges from about 6 inches to about 36 inches.

According to alternative embodiment AB, a method of making a cubicle curtain comprises the acts of providing a first portion adapted to attach to a curtain track, and coupling at least a portion of an at least one fabric band with at least a portion of a corresponding at least one vertical edge of the first portion, the at least one fabric band having antimicrobial properties.

According to alternative embodiment AC, the method of alternative embodiment AB, wherein the act of attaching the at least one fabric band includes banding.

According to alternative embodiment AD, the method of alternative embodiment AB, wherein the at least one fabric band comprises a fabric having antimicrobial properties.

According to alternative embodiment AE, the method of alternative embodiment AB, wherein the at least one fabric band includes an antimicrobial coating.

According to alternative embodiment AF, the method of alternative embodiment AB, wherein the first portion includes a main portion and an upper portion, the upper portion being adapted to attach to the curtain track.

According to alternative embodiment AG, a method of fitting an antimicrobial band to a cubicle curtain, the method comprises the acts of providing a cubicle curtain, and coupling at least a portion of at least one fabric band to at least a portion of at least one vertical edge of the cubicle curtain, the at least one fabric band having antimicrobial properties.

According to alternative embodiment AH, the method of alternative embodiment AG, wherein the act of attaching the at least one fabric band includes banding.

According to alternative embodiment Al, the method of alternative embodiment AG, wherein the at least one fabric band comprises a fabric having antimicrobial properties.

According to alternative embodiment AJ, the method of alternative embodiment AG, wherein the at least one fabric band includes an antimicrobial coating.

According to alternative embodiment AK, the method of alternative embodiment AG, wherein the first portion includes a main portion and an upper portion, the upper portion being adapted to be attached to the curtain track.

According to alternative embodiment AL, a fabric band comprises at least one fabric having antimicrobial properties and at least one attachment means positioned on the fabric band, wherein the fabric band is adapted to be coupled to at least a portion of a vertical end of a cubicle curtain to inhibit microbial growth.

According to alternative embodiment AM, the fabric band of alternative embodiment AL, wherein the fabric includes silver.

According to alternative embodiment AN, the fabric band of alternative embodiment AL further comprising a coating including chlorine, a chlorine-stabilizing compound, or a combination thereof.

According to alternative embodiment AO, the fabric band of alternative embodiment AL having a width ranging from about 6 to about 36 inches.

According to alternative embodiment AP, the fabric band of alternative embodiment AL further comprising at least one hole adapted to receive an at least one hook, the at least one hook being slidably mounted on a curtain track.

According to alternative embodiment AQ, the fabric band of alternative embodiment AL wherein the fabric band is adapted to be coupled to the vertical edge of the cubicle curtain using adhesive, stitching, hook-and-loop type fasteners such as Velcro®, or combinations thereof.

According to alternative embodiment AR, the fabric band of alternative embodiment AL further comprising a top portion coupled to a first edge of the at least one fabric, wherein the top portion includes at least one hole adapted to be coupled to a curtain track by receiving at least one hook slidably mounted to the curtain track.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the invention, which is set forth in the following claims.

What is claimed is:

1. A cubicle curtain comprising:
a main portion adapted to attach to a curtain track; and
at least one fabric band coupled with at least a portion of a corresponding at least one vertical end of the main portion, at least a portion of the at least one fabric band having antimicrobial properties.

2. The cubicle curtain of claim 1, wherein the at least one fabric band comprises a fabric having antimicrobial properties.

3. The cubicle curtain of claim 2, wherein the fabric includes silver.

4. The cubicle curtain of claim 1, wherein the at least one fabric band comprises a coating including chlorine, a chlorine-stabilizing compound, or a combination thereof.

5. The cubicle curtain of claim 1, wherein the main portion comprises a plurality of holes adapted to attach to the curtain track by receiving a plurality of hooks slidably mounted to the curtain track.

6. The cubicle curtain of claim 5, wherein the at least one fabric band comprises at least one hole adapted to attach to the curtain track by receiving at least one of the plurality of hooks.

7. The cubicle curtain of claim 6, wherein one of the plurality of holes positioned at or near at least one end of the main portion receives the at least one of the plurality of hooks.

8. The cubicle curtain of claim 1, wherein the width of the at least one fabric band ranges from about 6 inches to about 36 inches.

9. The cubicle curtain of claim 1, wherein the at least one fabric band is attached to the cubicle curtain by banding.

10. The cubicle curtain of claim 1, wherein the at least one fabric band is two fabric bands, each of the two fabric bands being attached to a corresponding vertical edge of the main portion.

11. A cubicle curtain comprising:
an upper portion adapted to attach to a curtain track;
a main portion attached to a bottom part of the upper portion; and
at least one fabric band coupled with at least a portion of a corresponding at least one vertical end of the main portion, at least a portion of the at least one fabric band having antimicrobial properties.

12. The cubicle curtain of claim 11, wherein the at least one fabric band comprises a fabric having antimicrobial properties.

13. The cubicle curtain of claim 12, wherein the fabric includes silver.

14. The cubicle curtain of claim 11, wherein the at least one fabric band comprises a coating including chlorine, a chlorine-stabilizing compound, or a combination thereof.

15. The cubicle curtain of claim 11, wherein the upper portion includes a plurality of holes adapted to attach to the curtain track by receiving a plurality of hooks slidably mounted to the curtain track.

16. The cubicle curtain of claim 11, wherein the width of the at least one fabric band ranges from about 6 inches to about 36 inches.

17. The cubicle curtain of claim 11, wherein the at least one fabric band is attached to the cubicle curtain by banding.

18. The cubicle curtain of claim 11, wherein the at least one fabric band is two fabric bands, each of the two fabric bands being attached to a corresponding vertical edge of the main portion.

19. A method of making a cubicle curtain comprising the acts of:
providing a first portion adapted to attach to a curtain track; and
coupling at least a portion of an at least one fabric band with at least a portion of a corresponding at least one vertical edge of the first portion, at least a portion of the at least one fabric band having antimicrobial properties.

20. The method of claim 19, wherein the act of attaching the at least one fabric band includes banding.

21. The method of claim 19, wherein the at least one fabric band comprises a fabric having antimicrobial properties.

22. The method of claim 19, wherein the at least one fabric band includes an antimicrobial coating.

23. The method of claim 19, wherein the first portion includes a main portion and an upper portion, the upper portion being adapted to be attached to the curtain track.

24. A method of fitting an antimicrobial band to a cubicle curtain, the method comprising the acts of:
providing a cubicle curtain; and
coupling at least a portion of at least one fabric band to at least a portion of at least one vertical edge of the cubicle curtain, the at least one fabric band having antimicrobial properties.

25. The method of claim 24, wherein the act of attaching the at least one fabric band includes banding.

26. The method of claim 24, wherein the at least one fabric band comprises a fabric having antimicrobial properties.

27. The method of claim 24, wherein the at least one fabric band includes an antimicrobial coating.

28. The method of claim 24, wherein the first portion includes a main portion and an upper portion, the upper portion being adapted to be attached to the curtain track.

29. A fabric band comprising:
at least one fabric having antimicrobial properties; and
at least one attachment means positioned on the fabric band, wherein the fabric band is adapted to be coupled to at least a portion of a vertical end of a cubicle curtain to inhibit microbial growth.

30. The fabric band of claim 29, wherein the fabric includes silver.

31. The fabric band of claim 29 further comprising a coating including chlorine, a chlorine-stabilizing compound, or a combination thereof.

32. The fabric band of claim 29 having a width ranging from about 6 to about 36 inches.

33. The fabric band of claim 29, further comprising at least one hole adapted to receive an at least one hook, the at least one hook being slidably mounted on a curtain track.

34. The fabric band of claim 29 wherein the fabric band is adapted to be coupled to the vertical edge of the cubicle curtain using adhesive, stitching, hook-and-loop type fasteners, or combinations thereof.

35. The fabric band of claim 29 further comprising a top portion coupled to a first edge of the at least one fabric, wherein the top portion includes at least one hole adapted to be coupled to a curtain track by receiving at least one hook slidably mounted to the curtain track.
